(19) United States
(12) Patent Application Publication
(10) Pub. No.: US 2007/0163652 A1
(43) Pub. Date: Jul. 19, 2007

(54) Release valve

(76) Inventors: Robert W. Pekar, Florence, MA (US); Scott R. Cadwallader, Northhampton, MA (US)

Correspondence Address: CANTOR COLBURN, LLP, 55 GRIFFIN ROAD SOUTH, BLOOMFIELD, CT, 06002, US

(21) Appl. No.: 11/649,597

(22) Filed: Jan. 4, 2007

Related U.S. Application Data
(60) Provisional application No. 60/756,481, filed on Jan. 4, 2006.

(51) Int. Cl. F16K 15/20

(52) U.S. Cl. 137/223

(57) ABSTRACT

A release valve including a top sheet; a bottom sheet sealed at a periphery to the top sheet at a perimeter seal; the bottom sheet including a release hole; the top sheet including an outlet. The top sheet and the bottom sheet provide one-way fluid flow from the release hole through the outlet.

### CROSS-REFERENCE TO RELATED APPLICATIONS

This application claims the benefit of U.S. provisional patent application Ser. No. 60/756,481 filed Jan. 4, 2006, the entire contents of which are incorporated herein by reference.

### BACKGROUND

This invention relates to valves and more particularly, to release valves for use with inflatable bladders. Inflatable bladders contain a fluid (e.g., air, liquid, gas) and typically utilize a release valve to allow the fluid to escape from the bladder. Existing release valves use a variety of elements made from differing materials such as hard plastics, metal stems, etc. These release valves can be difficult to manufacture and costly. Also, existing release valves may be too bulky for certain applications.

Thus, there is a need in the art for a low profile release valve having a simple construction.

### SUMMARY OF THE INVENTION

An embodiment of the invention is a release valve including a top sheet; a bottom sheet sealed at a periphery to the top sheet at a perimeter seal; the bottom sheet including a release hole; the top sheet including an outlet, wherein the top sheet and the bottom sheet provide one-way fluid flow from the release hole through the outlet.

### BRIEF DESCRIPTION OF THE DRAWINGS

FIG. 1 is a side view of a release valve in an embodiment of the invention.

FIG. 2 is a top view of the release valve in an embodiment of the invention.

FIG. 3 is a side view of a release valve in an alternate embodiment of the invention.

FIG. 4 is a top view of a release valve in an alternate embodiment of the invention.

FIG. 5 is a side cross-sectional view of a release valve in an alternate embodiment of the invention.

FIG. 6 is a side cross-sectional view of a release valve in an alternate embodiment of the invention.

FIG. 7 is a side cross-sectional view of a release valve in an alternate embodiment of the invention.

### DESCRIPTION

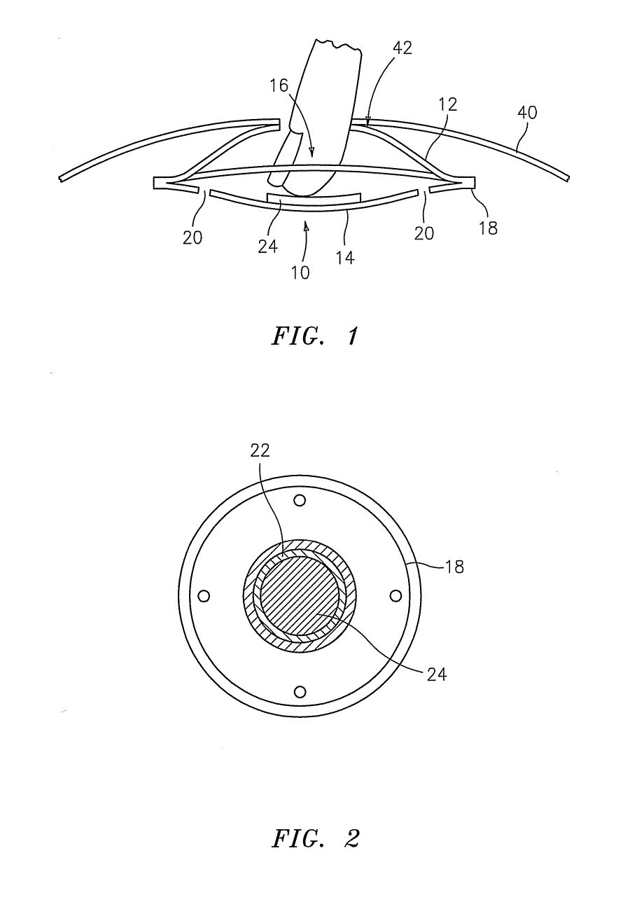

FIG. 1 is a side view of a release valve 10 installed on the interior of a bladder 40. The bladder 40 may be inflated with a fluid (e.g., air, liquid). The release valve 10 is sealed to the bladder 40 at a bladder opening 42. The release valve includes top sheet 12 and bottom sheet 14. Top sheet 12 includes an outlet 16 that is aligned with the bladder opening 42. The top sheet 12 and the bottom sheet 14 are sealed around their periphery at perimeter seal 18. Release holes 20 are formed in the bottom sheet 14.

In operation, the bladder is inflated with a fluid. The internal pressure forces the bottom sheet 14 against the top sheet 12 to seal the release holes 20 and the bladder opening 42. The interior surfaces of top sheet 12 and the bottom sheet 14 may be high gloss, cohesive surfaces. Thus, when the bladder 40 is pressurized, the top sheet 12 and bottom sheet 14 will exhibit substantial cohesion, blocking or surface-to-surface affinity which results in the two sheets having a tendency to stick together. This prevents fluid from exiting bladder 40 through valve 10.

To release fluid from the bladder, an object (e.g., a finger) may be inserted in the bladder opening 42 to separate the top sheet 12 and the bottom sheet 14. This creates a fluid path from the interior of the bladder 40, through release holes 20 and out bladder opening 42 through outlet 16. The number and/or size of the release holes may be selected so as to control the rate of fluid flow through the release holes 20. To cease escape of fluid from the bladder 40, the object is removed from bladder opening 42 causing sheets 12 and 14 to come together and form a fluid seal.

As shown in FIG. 2, the release valve 10 includes two seals, a perimeter seal 18 and an attachment seal 22. The top sheet 12 may be sealed to the bottom sheet 14 in a single operation by sealing the two sheets at the perimeter seal 18. An exemplary technique for forming the perimeter seal 18 is described in U.S. Pat. No. 5,144,708, the entire contents of which are incorporated herein by reference. In this technique, a die is filled with a central, non-heating portion such that a seal is only formed at perimeter 18. The top sheet 12 and the bottom sheet 14 may be made from thermoplastic sheet material such as polyurethane or polyvinylchloride. It is understood that other materials may be used such as other plastics, silicones, etc. and embodiments of the invention are not limited to thermoplastics. Top valve sheet 12 may be secured to the bottom sheet 14 through either bonding with an adhesive or fusing by applying energy (heat, ultrasonic welding, RF welding, etc.).

Release coating 24 (shown in FIG. 2 cross-hatched) is applied to the bottom sheet 14 and/or the top sheet 12 in the area overlapping outlet 16 in top sheet 12. The release coating 24 prevents the top sheet 12 from being sealed to the bottom sheet 14 when the attachment seal 22 is formed. The attachment seal 22 exists between the bladder wall 40 and the top sheet 12. The bladder 40 may be made from thermoplastic sheet material such as polyurethane or polyvinylchloride. It is understood that other materials may be used such as other plastics, silicones, etc. and embodiments of the invention are not limited to thermoplastics. Top valve sheet 12 may be secured to the bladder 40 through either bonding with an adhesive or fusing by applying energy (heat, ultrasonic welding, RF welding, etc.). The outlet 16 in top sheet 12 and bladder opening 42 are aligned, and the seal formed. The release coating 24 prevents the bottom sheet 14 from being sealed against top sheet 12. The release valve 10 in FIG. 2 is shown as circular, but embodiments of the invention are not limited to circular configurations (e.g. elliptical).

In alternate embodiments, materials that are not compatible with the top sheet and bottom sheet 14 may be used instead of release coatings. For example, in an area where it might be difficult to apply release coating, a heat active adhesive may be used to attach a nylon patch in the area where release coating 24 is shown. The nylon would not adhere to the top sheet 12 and bottomed sheet 14 (e.g., urethane materials) during a heat sealing process. Thus, the release element is not limited to coating, but may include patches of material.

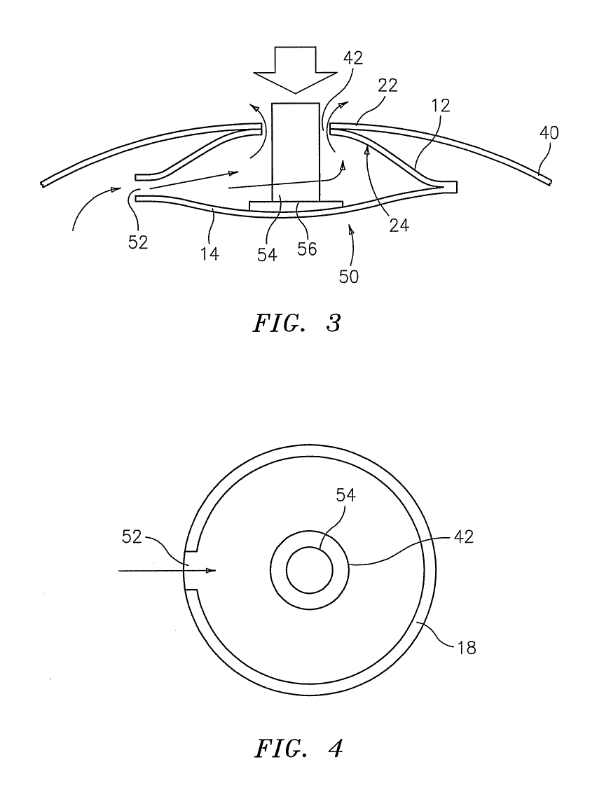

FIG. 3 illustrates a flat release valve in an alternate embodiment. Release valve 50 includes top sheet 12 and bottom sheet 14 similar to that in FIG. 1. The release valve 50 is sealed to bladder 40 in the same manner as shown in FIG. 1. Release coating 24 is positioned between top sheet 12 and bottom sheet 14 in the area surrounding attachment seal 22. As described above, the release coating prevents the top sheet 12 from being sealed to the bottom sheet 14 when release valve 50 is installed in bladder 40.

A difference between valve 50 and valve 10 is that the release holes 20 are presented in the form of a release channel 52. Further, a stem 54 has a stem face 56 positioned between the top sheet 12 and the bottom sheet 14. The stem face 56 may be sealed to the bottom sheet 14 using the techniques described herein (e.g. adhesive or fusing). To release fluid from the bladder 40, force is applied to stem 54 as shown in FIG. 3 to separate sheets 12 and 14 to allow fluid to travel through release channel 52.

FIG. 4 depicts the release channel 52 formed between the top sheet 12 and the bottom sheet 14. The release channel 52 is defined by an interruption in the perimeter seal 18. The interruption in seal 18 may be accomplished by applying a release coating to a section of the top sheet and bottom sheet when form seal 18. The width and length of the release channel 52 may be specific so as to control the rate of fluid flow from the bladder 40.

The flat valve in embodiments of the invention may be used as a valve in conjunction with a foam pump, such as that disclosed in U.S. Pat. No. 5,372,487, the entire contents of which are incorporated herein by reference. The foam pump may provide fluid through outlet 16 exiting release holes 20 to fill bladder 40.

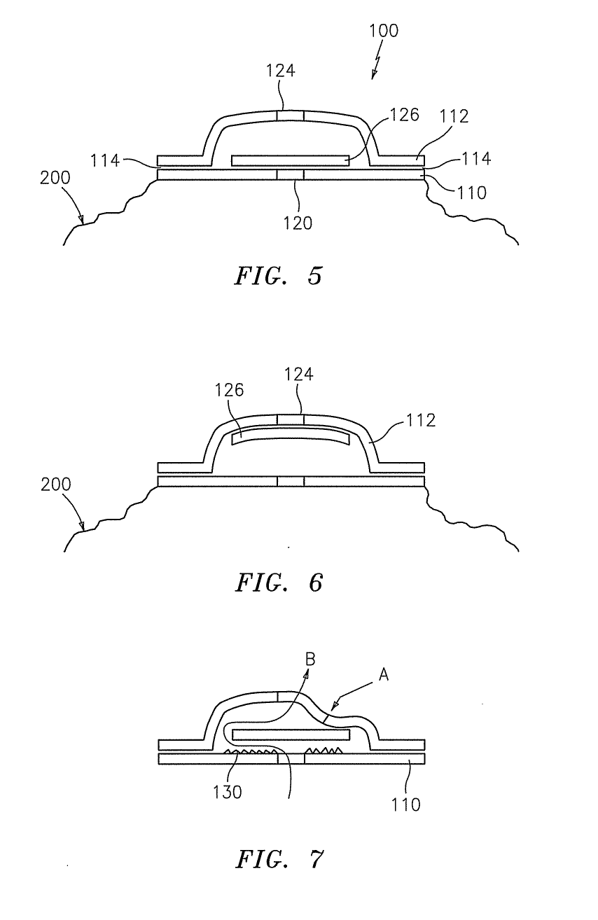

FIG. 5 is a cross-sectional view of a release valve 100 in an alternate embodiment of the invention. Release valve 100 includes a bottom sheet 110 and a top sheet 112. The top sheet 112 is formed in a dome shape and sealed around its periphery to the bottom sheet 110 at seal 114. Bottom sheet 110 and top sheet 112 may be made from thermoplastic sheet material such as polyurethane or polyvinylchloride. It is understood that other materials may be used such as other plastics, silicones, etc. and embodiments of the invention are not limited to thermoplastics. Top valve sheet 112 may be secured to the bottom sheet 110 through either bonding with an adhesive or fusing by applying energy (heat, ultrasonic welding, RF welding, etc.).

Release valve 100 is intended to be used with a bladder 200 and is secured to the bladder 200 on the outer surface of the bladder 200. In alternate embodiments, the release valve 100 may be mounted on the interior of bladder 200. Bottom sheet 110 may be secured to the bladder 200 through either bonding with an adhesive or fusing by applying energy (heat, ultrasonic welding, RF welding, etc.). One or more release holes 120 are formed in the bottom sheet 110. Release hole 120 is in fluid communication with the internal portion of the bladder 200.

Top sheet 112 includes an outlet 124. Between the bottom sheet 110 and the top sheet 112 is a valve member 126. The valve member 126 is a circular sheet of thin film material. It is understood that the valve member may have different shapes than circular, such elliptical, etc. The valve member 126 may be made from a flexible urethane film or other material.

When bladder 200 is pressurized with a fluid (e.g., air, liquid), the valve member 126 is lifted upwards towards top sheet 112 and seals around outlet 124 as shown in FIG. 6 to prevent fluid from escaping bladder 200. The interior surfaces of top sheet 112 and upper surface of valve member 126 may be high gloss, cohesive surfaces. Thus, when the bladder 200 is pressurized, the top sheet 112 and valve member 126 will exhibit substantial cohesion, blocking or surface-to-surface affinity which results in the two sheets having a tendency to stick together. This prevents fluid from exiting bladder 200 through opening 124.

To release fluid from bladder 200, pressure is applied to the dome-shaped top sheet 112 as shown by arrow A in FIG. 7. This allows fluid to escape around valve member 126 as shown by arrow B. As shown in FIG. 7, the bottom sheet may include a textured surface 130. The textured surface 130 prevents valve member 126 from forming a seal against bottom sheet 110. This allows fluid to flow in from opening 124 through release hole 120, if desired.

While this invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A release valve comprising:
a top sheet;
a bottom sheet sealed at a periphery to the top sheet at a perimeter seal;
the bottom sheet including a release hole;
the top sheet including an outlet,
wherein the top sheet and the bottom sheet provide one way fluid flow from the release hole through the outlet.

2. The release valve of claim 1 further comprising:
a bladder having an opening;
the release valve positioned within the bladder, the top sheet sealed to the bladder at an attachment seal such that the outlet is in fluid communication with the opening.

3. The release valve of claim 1 further comprising:
a release coating on the bottom sheet, the release coating overlapping the outlet in the top sheet.

4. The release valve of claim 1 wherein:
interior, facing surfaces of the top sheet and the bottom sheet are high gloss, cohesive surfaces.

5. The release valve of claim 1 wherein:
top sheet and the bottom sheet are made from thermoplastic materials.

6. The release valve of claim 1 further comprising:
a nylon patch on the bottom sheet, the nylon patch overlapping the outlet in the top sheet.

7. The release valve of claim 2 wherein:
the release hole is a release channel allowing fluid flow through the perimeter seal.

8. The release valve of claim 7 further comprising:
a stem extending through the opening in the bladder and the outlet in the top sheet.

9. The release valve of claim 8 wherein:
the stem includes a stem face secured to the bottom sheet.

10. The release valve of claim 1 further comprising:
a bladder having an opening;
the release valve positioned outside the bladder, the bottom sheet sealed to the bladder at an attachment seal such that the release hole is in fluid communication with the opening.

11. The release valve of claim 10 wherein:
the top sheet is a dome-shaped sheet.

12. The release valve of claim 11 further comprising:
a valve member positioned between the top sheet and the bottom sheet, the valve member movable to seal against the top sheet.

13. The release valve of claim 12 wherein:
the bottom sheet includes a textured surface to prevent the valve member from sealing against the bottom sheet.
